(19) United States
(12) Patent Application Publication
(10) Pub. No.: US 2022/0027705 A1
(43) Pub. Date: Jan. 27, 2022

(54) BUILDING POSITIONING METHOD, ELECTRONIC DEVICE, STORAGE MEDIUM AND TERMINAL DEVICE

(71) Applicant: Beijing Baidu Netcom Science Technology Co., Ltd., Beijing (CN)

(72) Inventors: Zhi WANG, Beijing (CN); Min LIU, Beijing (CN); Hailu JIA, Beijing (CN)

(21) Appl. No.: 17/494,497

(22) Filed: Oct. 5, 2021

(30) Foreign Application Priority Data
Feb. 9, 2021 (CN) 202110179433.8

(51) Int. Cl. G06N 3/04; G01C 21/20; G06N 3/08; H04W 4/021

(52) U.S. Cl. CPC G06N 3/0427; H04W 4/021; G06N 3/08; G01C 21/20

(57) ABSTRACT

A building positioning method, an electronic device, a storage medium and a terminal device are disclosed, which relate to the technical fields of artificial intelligence, computer vision domains and intelligent traffic. The method includes: acquiring a building fingerprint library, the building fingerprint library including a plurality of groups of triplet data and a plurality of corresponding building information, wherein a single group of triplet data includes surveying and mapping data, GPS data and Wi-Fi data; receiving a positioning request, the positioning request including first triplet data, the first triplet data including first surveying and mapping data, first GPS data, and first Wi-Fi data; calculating a similarity between the first triplet data and the plurality of groups of triplet data in the building fingerprint library, respectively; and determining building information corresponding to the positioning request according to the calculated similarity.

### CROSS-REFERENCE TO RELATED APPLICATION

This application claims priority to Chinese Patent Application No. 202110179433.8, filed on Feb. 9, 2021, which is hereby incorporated by reference in its entirety.

### TECHNICAL FIELD

The present disclosure relates to the technical fields of artificial intelligence, computer vision and intelligent traffic, and in particular to a building positioning method, a building positioning apparatus, a building positioning device, a storage medium, a computer program product and a terminal device.

### BACKGROUND

At present, with the rapid development of the mobile internet technology, the positioning technology for the position of the user plays a key role in various scenes and applications. When the user is outdoors, the electronic device can acquire higher-precision positioning depending on the satellite. When the user is indoors, civil equipment hardly acquires satellite data, therefore the satellite data cannot be directly utilized to realize positioning. Operation of a plurality of application programs (app) needs to be according to the building information of the user, in order to activate the corresponding function, providing better service. When the user is indoors, it needs to rely on auxiliary information to make positioning, and can correctly deduce the building where the user is positioned. There are two main solutions at present, the first is to utilize the co-occurrence relation of global positioning system (GPS) and Wi-Fi (“action hot spot” in wireless communication technology) to construct Wi-Fi fingerprint, and then make positioning by means of Wi-Fi fingerprint; the second is to, based on the co-occurrence relation between GPS and Wi-Fi, the co-occurrence relation between and the correspondence between Service Set identifier (SSID) of Wi-Fi and name of Point of interest (POI), deduce the position of each Wi-Fi offline; in a case that a positioning request is initiated, to estimate the building where the user is located by combining information at the time of initiation of the request by the device with each Wi-Fi location estimated offline.

### SUMMARY

The present disclosure provides a building positioning method, a building positioning apparatus, a building positioning device, a storage medium, a computer program product and a terminal device, for solving at least one of the above problems.

According to a first aspect of the present disclosure, there is provided a building positioning method including:

acquiring a building fingerprint library, the building fingerprint library including a plurality of groups of triplet data and a plurality of corresponding building information, wherein a single group of triplet data includes surveying and mapping data, GPS data and Wi-Fi data;

receiving a positioning request, the positioning request including first triplet data, the first triplet data including first surveying and mapping data, first GPS data, and first Wi-Fi data;

calculating a similarity between the first triplet data and the plurality of groups of triplet data in the building fingerprint library, respectively; and

determining building information corresponding to the positioning request according to the calculated similarity;

wherein constructing the building fingerprint library includes:

collecting a plurality of groups of triplet data, annotating each group of triplet date with corresponding building information, using a plurality of groups of annotated triplet data as training data to train a neural network, and obtaining a building positioning model after training;

inputting a plurality of groups of triplet data to be positioned into the building positioning model for positioning to obtain a plurality of building information; and

constructing the building fingerprint library based on the plurality of groups of annotated triplet data and the plurality of groups of triplet data positioned by the building positioning model.

According to a second aspect of the present disclosure, there is provided a building positioning apparatus including:

an acquisition module, configured for acquiring a building fingerprint library, the building fingerprint library including a plurality of groups of triplet data and a plurality of corresponding building information, wherein a single group of triplet data includes surveying and mapping data, OPS data and Wi-Fi data;

a receiving module, configured for receiving a positioning request, the positioning request including first triplet data, the first triplet data including first surveying and mapping data, first GPS data, and first Wi-Fi data;

a calculation module, configured for calculating a similarity between the first triplet data and the plurality of groups of triplet data in the building fingerprint library, respectively; and

a determination module, configured for determining building information corresponding to the positioning request according to the calculated similarity;

wherein a construction apparatus for constructing the building fingerprint library includes:

a training assembly, configured for collecting a plurality of groups of triplet data, annotating each group of triplet date with corresponding building information, using a plurality of groups of annotated triplet data as training data to train a neural network, and obtaining a building positioning model after training;

an input assembly, configured for inputting a plurality of groups of triplet data to be positioned into the building positioning model for positioning to obtain a plurality of building information; and

a constructing assembly, configured for constructing the building fingerprint library based on the plurality of groups of annotated triplet data and the plurality of groups of triplet data positioned by the building positioning model.

According to a third aspect of the present disclosure, there is provided an electronic device including:

at least one processor; and

a memory communicatively coupled to the at least one processor; wherein

the memory is stored with instructions executable by the at least one processor to enable the at least one processor to implement the abovementioned method.

According to a fourth aspect of the present disclosure. there provided a non-transitory computer-readable storage medium being stored with computer instructions for causing a computer to perform the abovementioned method.

According to a fifth aspect of the present disclosure, there is provided a computer program product including a computer program that, when executed by a processor, implements the abovementioned method.

According to a sixth aspect of the present disclosure, there is provided a terminal device including: a processor; and a memory configured for storing a computer program; the processor calling and executing the computer program stored in the memory, and executing the abovementioned method.

It is to be understood that the contents in this section are not intended to identify the key or critical features of the embodiments of the present disclosure, and are not intended to limit the scope of the present disclosure. Other features of the present disclosure will become readily apparent from the following description.

### BRIEF DESCRIPTION OF THE DRAWINGS

The drawings are included to provide a better understanding of the present disclosure and are not to be construed as limiting the present disclosure. Wherein:

FIG. 1 is a flow block diagram of a building positioning method according to an embodiment of the present disclosure;

FIG. 2 is a flow schematic diagram of a building positioning method according to another embodiment of the present disclosure;

FIG. 3 is a schematic diagram of the effect of using the embodiment of the present disclosure to locate a building;

FIG. 4 is a structural block diagram of a building positioning device according to an embodiment of the present disclosure; and

FIG. 5 is a block diagram of an electronic device that implements the building positioning method according to an embodiment of the present disclosure.

### DETAILED DESCRIPTION

Exemplary embodiments of the present disclosure are described below with reference to the accompanying drawings, wherein the various details of the embodiments of the present disclosure are included to facilitate understanding and are to be considered as exemplary only. Accordingly, a person skilled in the art should appreciate that various changes and modifications can be made to the embodiments described herein without departing from the scope and spirit of the present disclosure. Also, descriptions of well-known functions and structures are omitted from the following description for clarity and conciseness.

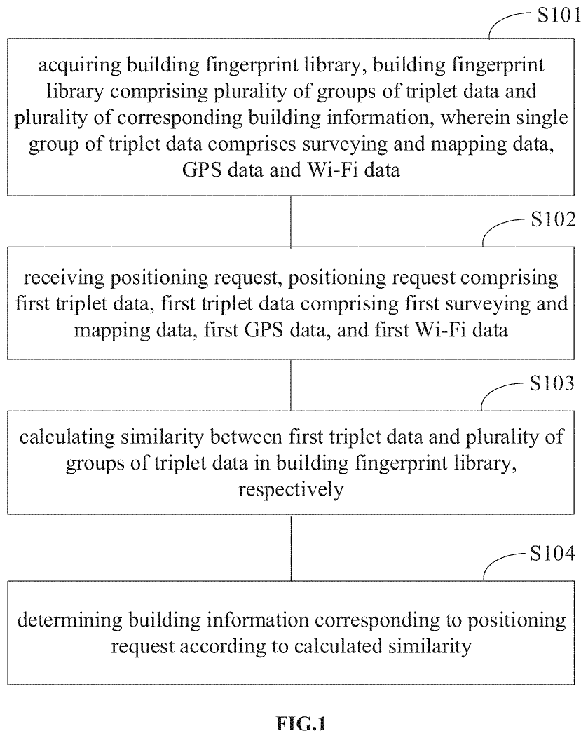

FIG. 1 is a flow block diagram of a building positioning method provided by an embodiment of the present disclosure. The method includes:

S101, acquiring a building fingerprint library, the building fingerprint library including a plurality of groups of triplet data and a plurality of corresponding building information, wherein a single group of triplet data includes surveying and mapping data, GPS data and Wi-Fi data;

S102, receiving a positioning request, the positioning request including first triplet data, the first triplet data including first surveying and mapping data, first GPS data, and first Wi-Fi data;

S103, calculating a similarity between the first triplet data and the plurality of groups of triplet data in the building fingerprint library, respectively; and

S104, determining building information corresponding to the positioning request according to the calculated similarity;

wherein constructing the building fingerprint library includes: collecting a plurality of groups of triplet data, annotating each group of triplet date with corresponding building information, using a plurality of groups of annotated triplet data as training data to train a neural network, and obtaining a building positioning model after training; inputting a plurality of groups of triplet data to be positioned into the building positioning model for positioning to obtain a plurality of building information; and constructing the building fingerprint library based on the plurality of groups of annotated triplet data and the plurality of groups of triplet data positioned by the building positioning model.

According to embodiments of the present disclosure, first the indoor fingerprint library of each building can be constructed based on deep learning. By matching the similarities between the data carried in the positioning request to the data within the build fingerprint library, the corresponding building information can be obtained. Embodiments of the present disclosure uses co-occurrence relation between space and multi-Wi-Fi information to infer the fingerprint position, it is more accurately predicting the real building where the user is located, avoiding problems of inaccurate inferences based on data only. And, embodiments of the present disclosure can utilize training model to predict buildings corresponding to a large amount of fingerprint data to be positioned, and a large amount of building fingerprint library data can be obtained. The larger the amount of constructed fingerprint library data is, the higher the positioning result accuracy obtained according to the similarity match is.

According to embodiments of the present disclosure, optionally, the using the plurality of groups of annotated triplet data as the training data to train the neural network, and obtaining the building positioning model after training, includes: inputting the collected triplet data into a first neural network, obtaining at least one coordinate data outputted by the first neural network, determining a building according to the at least one coordinate data, using a difference between the determined building and the annotated building as a loss, performing parameter adjustment on the first neural network, and ending training in a case that a training stop condition is reached to obtain the building positioning model; wherein the collected triplet data includes collected surveying and mapping data, collected GPS data and collected Wi-Fi data, the surveying and mapping data, the GPS data and the Wi-Fi data in a single group of triplet data correspond to same collecting position and same collecting moment.

In embodiments of the present disclosure, the GPS data, the Wi-Fi data and the map surveying and mapping data collected at the same position and at the same moment is used as a triplet data. By collecting a large amount of triplet data and labeling the corresponding buildings, the training data used to train the neural network (which can also be used as the data of the building fingerprint library) is constructed, and the neural network is trained with high-quality training data to obtain the required building positioning model.

According to embodiments of the present disclosure, optionally, the inputting the collected triplet data into the first neural network, includes: generating two-dimensional matrices based on the collected surveying and mapping data, the collected GPS data, and the collected Wi-Fi data, respectively, and inputting three generated two-dimensional matrices, as three-channel data, into the first neural network.

In embodiments of the present disclosure, three two-dimensional matrices are used as a three-channel data input to the neural network for training, and integrates the information of GPS data, Wi-Fi data and map surveying and mapping data, which can more accurately locate the positioning of the collection point and improve the prediction accuracy and precision of the model generated after training.

According to embodiments of the present disclosure, optionally, the determining the building according to the at least one coordinate data, includes at least one of:

\hat{1} determining a first position point based on the at least one coordinate data, the determined building being a building where the first position point is located;

\hat{2} determining a plurality of position points based on the at least one coordinate data, the determined building being a building surrounded by a surrounding frame constituted by the plurality of position points.

According to the coordinates output by the neural network, it can correspond to a specific building, achieving the purpose of determining the building based on the triple data.

According to embodiments of the present disclosure, optionally, the surveying and mapping data includes at least one selected from building block shape, building floor height, and point-of-interest POI information corresponding to the building.

For example, the building block shape can be, for example, the building block shape when viewed from above (such as rectangle, oval, irregular shape, etc.); the building floor height can be the height of the floor where the user is located; the point-of-interest POI information corresponding to the building may be the existing POI information of the building. Map surveying and mapping data can be acquired from the outside, for example, acquired from some electronic map data, or acquired from a specialized map surveying and mapping database. Using surveying and mapping data, GPS information and Wi-Fi information to jointly infer the position of the fingerprint, it can be more accurately predict the real building where the user is located, improving the accuracy of positioning.

By using at least one of the above-mentioned embodiments of the present disclosure, the problem of building inference can be solved by using GPS information, Wi-Fi data, and map surveying data, combined with target detection related algorithms, so as to achieve the goal of improving the judgment accuracy of the building where the user is located.

Implementation of the building positioning method in the embodiments of the present disclosure and the advantages obtained are described above. The specific processing procedures of the embodiments of the present disclosure are described in detail below through specific examples.

In an embodiment of the present disclosure, the indoor fingerprint library of each building is first constructed, and then the user positioning request is compared in the fingerprint library of each building, so as to infer the real building where the user is located. The indoor fingerprint library of each building can be constructed by the following processing.

(1) Use map surveying and mapping data (such as building block shape, height and/or POI information, etc.), GPS collection point data and Wi-Fi collection point data, each user fingerprint is generated into a set of multiple two-dimensional matrices, here each user fingerprint corresponds to the Wi-Fi information scanned at a certain moment.

(2) Use AP-POI (wireless access point—point-of-interest) and collected real data to construct a true value, and train a target detection model (that is, a building positioning model), here the AP-POI data is obtained through data mining and has a real positioning fingerprint data.

(3) Use the trained model to predict the building corresponding to a new user's fingerprint.

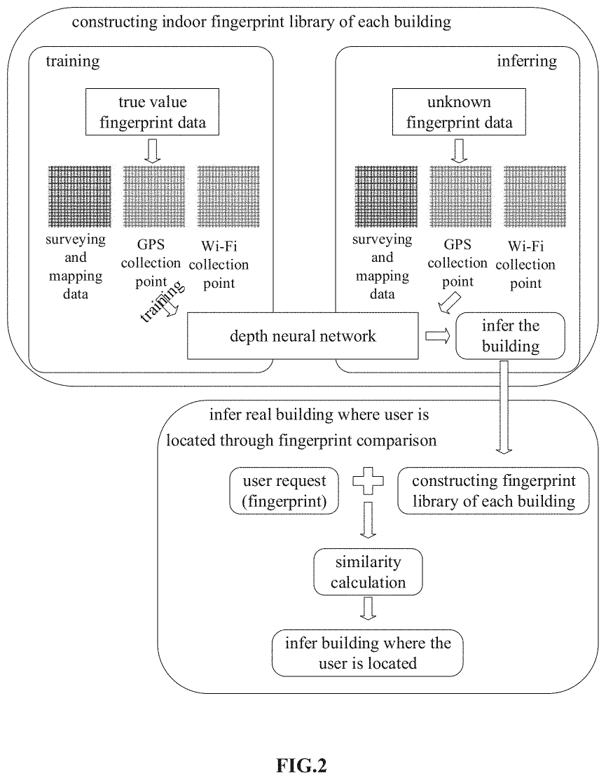

Referring to FIG. 2, in another embodiment of the present disclosure, taking the location of a mobile phone user's building as an example, a fingerprint contains all Wi-Fi information scanned by the mobile client at a certain moment. In order to confirm the real building where the fingerprint is located, the following processing is performed as follows.

(1) Offline mining: mining a batch of buildings where fingerprints are located, and constructing a building fingerprint library;

(2) Online positioning: according to the fingerprint at the time the user initiates the positioning, find the similar fingerprint in the constructed building fingerprint library, and infer the user's current fingerprint position based on the building information of the similar fingerprint, that is, the building where the user is located.

Further, for the (1) offline mining stage, through deep learning, the target detection model is used to infer the building where the fingerprint is located during offline mining, base on which the building fingerprint library is constructed, where

\hat{1} The input of the model can be a set of two-dimensional matrices, and the generated matrix combines map surveying and mapping data, GPS collection point data, and Wi-Fi collection point data. Referring to FIG. 2, a two-dimensional matrix is generated on each of the three data, as a three-channel data, input to the neural network.

\hat{2} The output of the model can be the coordinate point in the matrix (corresponding to the element in the matrix), the building selected by the model can be confirmed through multiple coordinates. For example, two coordinates can be to obtain a rectangular box, and a building can be selected by, the box, this building is the one corresponding to the three-channel data mentioned in \hat{1}.

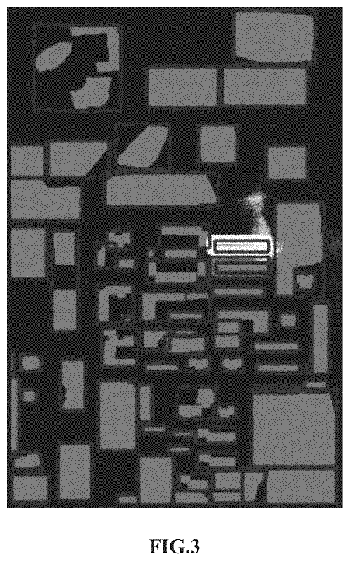

The model according to embodiments of the present disclosure uses a true value position of fingerprint data in the training stage. Using the well-trained model can realize: (1) the task in the offline mining stage, each fingerprint can be configured to build a set of two-dimensional matrices, for each set of two-dimensional matrices, the building can be determined through the model, which is to determine the buildings where each fingerprint is located, after accumulated for a period of time, it can predict a large number of fingerprint data through the model, and build building fingerprint library; (2) the positioning task in the online positioning, new fingerprints can be matched in the fingerprint library to find similar fingerprints, and the building and position of the user can be determined according to the fingerprints of high similarity. FIG. 3 schematically shows a schematic view of a building positioning according to an embodiment of the present disclosure embodiment, and FIG. 3 is a top plan view of a building group, wherein the light-colored area is a building positioned where the user is located.

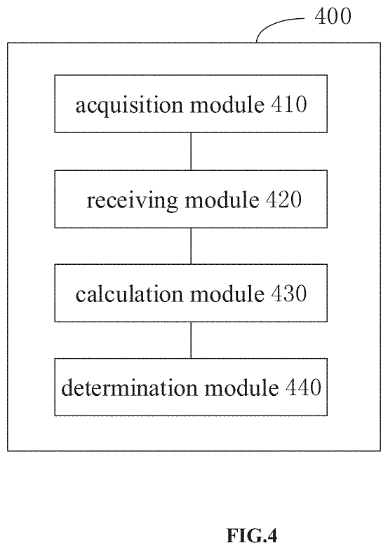

The specific settings and implementations of embodiments of the present disclosure will be described by multiple embodiments from different angles. Corresponding to the processing method of at least one embodiment abovementioned, embodiments of the present disclosure also provide a building positioning apparatus 400; referring to FIG. 4, including:

an acquisition module 410, configured for acquiring a building fingerprint library, the building fingerprint library including a plurality of groups of triplet data and a plurality of corresponding building information, wherein a single group of triplet data includes surveying and mapping data, GPS data and Wi-Fi data;

a receiving module 420, configured for receiving a positioning request, the positioning request including first triplet data, the first triplet data including first surveying and mapping data, first GPS data, and first Wi-Fi data;

a calculation module 430, configured for calculating a similarity between the first triplet data and the plurality of groups of triplet data in the building fingerprint library, respectively; and

a determination module 440, configured for determining building information corresponding to the positioning request according to the calculated similarity; wherein a construction apparatus for constructing the building fingerprint library includes:

a training assembly, configured for collecting a plurality of groups of triplet data, annotating each group of triplet date with corresponding building information, using a plurality of groups of annotated triplet data as training data to train a neural network, and obtaining a building positioning model after training;

an input assembly, configured for inputting a plurality of groups of triplet data to be positioned into the building positioning model for positioning to obtain a plurality of building information; and

a constructing assembly, configured for constructing the building fingerprint library based on the plurality of groups of annotated triplet data and the plurality of groups of triplet data positioned by the building positioning model.

Alternatively, the training assembly is configured for inputting the collected triplet data into a first neural network, obtaining at least one coordinate data outputted by the first neural network, determining a building according to the at least one coordinate data, using a difference between the determined building and the annotated building as a loss, performing parameter adjustment on the first neural network, and ending training in a case that a training stop condition is reached to obtain the building positioning model; wherein the collected triplet data includes collected surveying and mapping data, collected GPS data and collected Wi-Fi data, the surveying and mapping data, the GPS data and the data in a single group of triplet data correspond to same collecting position and same collecting moment.

Optionally, the input assembly is configured for generating two-dimensional matrices based on the collected surveying and mapping data, the collected GPS data, and the collected Wi-Fi data, respectively, and inputting three generated two-dimensional matrices, as three-channel data, into the first neural network.

Optionally, the training assembly is configured for determining a first position point based on the at least one coordinate data, the determined building being a building where the first position point is located; alternatively, the training assembly is configured for determining a plurality of position points based on the at least one coordinate data, the determined building being a building surrounded by a surrounding frame constituted by the plurality of position points.

Optionally, the surveying and mapping data includes at least one selected from building block shape, building floor height, and point-of-interest POI information corresponding to the building.

For the functions of the modules in the apparatuses of the embodiments of the present disclosure, reference may be made to the description in the various embodiments of the abovementioned method, which will not be repeated here.

According to the embodiments of the present disclosure, the present disclosure also provides an electronic device, a readable storage medium, and a computer program product.

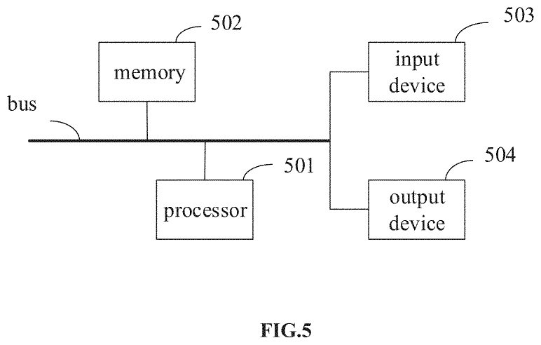

FIG. 5 is a schematic block diagram showing an electronic device 500 that may be configured for implementing the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular telephones, cellular phones, smart phones, wearable devices, and other similar computing devices. The components shown herein, their connections and relationships, and their functions are by way of example only and are not intended to limit the implementations of the present disclosure described and/or claimed herein.

As shown in FIG. 5, the electronic device includes: one or more processors 501, memory 502, and interfaces for connecting various components, including high-speed interfaces and low-speed interfaces. The various components are interconnected using different buses and may be mounted on a common motherboard or otherwise as desired. The processor may process instructions for execution within the electronic device, including instructions stored in the memory or on the memory to display graphical information of a Graphical User Interface (GUI) on an external input/output device, such as a display apparatus coupled to the interface. In other embodiments, multiple processors and/or multiple buses and multiple memories may be used with multiple memories if desired. Similarly, multiple electronic devices may be connected, each providing part of the necessary operations (e.g., as an array of servers, a set of blade servers, or a multiprocessor system). In FIG. 5, one processor 501 is taken as an example.

The memory 502 is a non-transitory computer-readable storage medium provided by the present disclosure. The memory stores instructions executable by at least one processor to enable the at least one processor to implement the building positioning method provided by the present disclosure. The non-transitory computer-readable storage medium of the present disclosure stores computer instructions for enabling a computer to implement the building positioning method provided by the present disclosure.

The memory 502, as a non-transitory computer-readable storage medium, may be used to store non-transitory software programs, non-transitory computer-executable programs, and modules, such as program instructions/modules corresponding to the building positioning method according to embodiments of the present disclosure. The processor 501 executes various functional applications of the server and data processing, i.e., achieving the building positioning method in the above-mentioned method embodiment, by operating non-transitory software programs, instructions, and modules stored in the memory 502.

The memory 502 may include a program storage area and a data storage area, wherein the program storage area may store an application program required by an operating system and at least one function; the data storage area may store data created according to the use of the electronic apparatus of the data processing method based on the recurrent neural network, etc. In addition, the memory 502 may include high speed random access memory, and may also include a non-transitory memory, such as at least one magnetic disk storage apparatus, a flash memory apparatus, or other non-transitory solid state memory apparatus. In some embodiments, the memory 502 may optionally include memories remotely located with respect to processor 501, which may be connected via a network to the electronic device for analysis and processing of search results. Examples of such networks include, but are not limited to, the Internet, intranet, local area networks, mobile communication networks, and combinations thereof.

The electronic device of the building positioning method according to embodiments of the present disclosure may further include: an input device 503 and an output device 504. The processor 501, the memory 502, the input device 503, and the output device 504 may be connected via a bus or otherwise, FIG. 5 in the embodiment of the present disclosure takes a bus connection as an example.

The input device 503 may receive input numeric or character information and generate key signal inputs related to user settings and functional controls of the electronic device for analysis and processing of search results, such as input devices including touch screens, keypads, mice, track pads, touch pads, pointing sticks, one or more mouse buttons, track balls, joysticks, etc. The output devices 504 may include display devices, auxiliary lighting devices (e.g., LEDs), tactile feedback devices (e.g., vibration motors), and the like. The display apparatus may include, but is not limited to, a Liquid Crystal Display (LCD), a Light Emitting Diode (LED) display, and a plasma display. In some embodiments, the display apparatus may be a touch screen.

Various embodiments of the systems and techniques described herein may be implemented in digital electronic circuit systems, integrated circuit systems, Application Specific Integrated Circuits (ASICs), computer hardware, firmware, software, and/or combinations thereof. These various embodiments may include: implementation in one or more computer programs which can be executed and/or interpreted on a programmable system including at least one programmable processor, and the programmable processor may be a dedicated or general-purpose programmable processor which can receive data and instructions from, and transmit data and instructions to, a memory system, at least one input device, and at least one output device.

These computing programs (also referred to as programs, software, software applications, or code) include machine instructions of a programmable processor, and may be implemented using high-level procedural and/or object-oriented programming languages, and/or assembly/machine languages. As used herein, the terms “machine-readable medium” and “computer-readable medium” refer to any computer program product, device, and/or apparatus (e.g., magnetic disk, optical disk, memory, programmable logic apparatus (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

To provide for interaction with a user, the systems and techniques described herein may be implemented on a computer having: a display apparatus (e.g., a Cathode Ray Tube (CRT) or Liquid Crystal Display (LCD) monitor) for displaying information to a user; and a keyboard and a pointing apparatus (e.g., a mouse or a trackball) by which a user can provide input to the computer. Other types of devices may: also be used to provide interaction with a user; for example, the feedback provided to the user may be any for of sensory feedback (e.g., visual feedback, audile feedback, or tactile feedback); and input from the user may be received in any form, including acoustic input, audio input, or tactile input.

The systems and techniques described herein may be implemented in a computing system that includes a background component (e.g., as a data server), or a computing system that includes a middleware component (e.g., an application server), or a computing system that includes a front-end component (e.g., a user computer having a graphical user interface or a web browser through which a user may interact with embodiments of the systems and techniques described herein), or in a computing system that includes any combination of such background component, middleware component, or front-end component. The components of the system may be interconnected by digital data communication (e.g., a communication network) of any form or medium. Examples of the communication networks include: Local Area Networks (LANs), Wide Area Networks (WANs), and the Internet.

The computer system may include a client and a server. The client and the server are typically remote from each other and typically interact through a communication network. A relationship between the client and the server is generated by computer programs operating on respective computers and having a client-server relationship with each other.

It will be appreciated that the various forms of flow, reordering, adding or removing operations shown above may be used. For example, the operations recited in the present disclosure may be performed in parallel or sequentially or may be performed in a different order, so long as the desired results of the technical solutions disclosed in the present disclosure can be achieved, and no limitation is made herein. The above-mentioned embodiments are not to be construed as limiting the scope of the present disclosure. It will be apparent to a person skilled in the art that various modifications, combinations, sub-combinations and substitutions are possible, depending on design requirements and other factors. Any modifications, equivalents, and improvements within the spirit and principles of the present disclosure are intended to be included within the scope of the present disclosure.

What is claimed is:

1. A building positioning method comprising:
acquiring a building fingerprint library, the building fingerprint library comprising a plurality of groups of triplet data and a plurality of corresponding building information, wherein a single group of triplet data comprises surveying and mapping data, GPS data and Wi-Fi data;
receiving a positioning request, the positioning request comprising first triplet data, the first triplet data comprising first surveying and mapping data, first GPS data, and first Wi-Fi data;
calculating a similarity between the first triplet data and the plurality of groups of triplet data in the building fingerprint library, respectively; and
determining building information corresponding to the positioning request according to the calculated similarity;
wherein constructing the building fingerprint library comprises:
collecting a plurality of groups of triplet data, annotating each group of triplet date with corresponding building information, using a plurality of groups of annotated triplet data as training data to train a neural network, and obtaining a building positioning model after training;
inputting a plurality of groups of triplet data to be positioned into the building positioning model for positioning to obtain a plurality of building information; and
constructing the building fingerprint library based on the plurality of groups of annotated triplet data and the plurality of groups of triplet data positioned by the building positioning model.

2. The method of claim 1, wherein the using the plurality of groups of annotated triplet data as the training data to train the neural network, and obtaining the building positioning model after training, comprising:
inputting the collected triplet data into a first neural network, obtaining at least one coordinate data outputted by the first neural network, determining a building according to the at least one coordinate data, using a difference between the determined building and the annotated building as a loss, performing parameter adjustment on the first neural network, and ending training in a case that a training stop condition is reached to obtain the building positioning model;
wherein the collected triplet data comprises collected surveying and mapping data, collected GPS data and collected Wi-Fi data, the surveying and mapping data, the GPS data and the Wi-Fi data in a single group of triplet data correspond to same collecting position and same collecting moment.

3. The method of claim 2, wherein the inputting the collected triplet data into the first neural network, comprises:
generating two-dimensional matrices based on the collected surveying and mapping data, the collected GPS data, and the collected Wi-Fi data, respectively, and inputting three generated two-dimensional matrices, as three-channel data, into the first neural network.

4. The method of claim 2, wherein the determining the building according to the at least one coordinate data, comprises:
determining a first position point based on the at least one coordinate data, the determined building being a building where the first position point is located;
alternatively,
determining a plurality of position points based on the at least one coordinate data, the determined building being a building surrounded by a surrounding frame constituted by the plurality of position points.

5. The method of claim 1, wherein the surveying and mapping data. comprises at least one selected from building block shape, building floor height; and point-of-interest POI information corresponding to the building.

6. An electronic device, comprising:
at least one processor; and
a memory communicatively coupled to the at least one processor; wherein
the memory is stored with instructions executable by the at least one processor to enable the at least one processor to perform operations of:
acquiring a building fingerprint library, the building fingerprint library. comprising a plurality of groups of triplet data and a plurality of corresponding building information, wherein a single group of triplet data. comprises surveying and mapping data, GPS data and Wi-Fi data;
receiving a positioning request, the positioning request comprising first triplet data, the first triplet data comprising first surveying and mapping data, first GPS data, and first Wi-Fi data;
calculating a similarity between the first triplet data and the plurality of groups of triplet data in the building fingerprint library, respectively; and
determining building information corresponding to the positioning request according to the calculated similarity;
wherein constructing the building fingerprint library comprises:
collecting a plurality of groups of triplet data, annotating each group of triplet date with corresponding building information, using a plurality of groups of annotated triplet data as training data to train a neural network, and obtaining a building positioning model after training;
inputting a plurality of groups of triplet data to be positioned into the building positioning model for positioning to obtain a plurality of building information; and
constructing the building fingerprint library based on the plurality of groups of annotated triplet data and the plurality of groups of triplet data positioned by the building positioning model.

7. The electronic device of claim 6, wherein the using the plurality of groups of annotated triplet data as the training data to train the neural network, and obtaining the building positioning model after training, comprising:
inputting the collected triplet data into a first neural network, obtaining at least one coordinate data outputted by the first neural network, determining a building according to the at least one coordinate data, using a difference between the determined building and the annotated building as a loss, performing parameter adjustment on the first neural network, and ending training in a case that a training stop condition is reached to obtain the building positioning model;
wherein the collected triplet data comprises collected surveying and mapping data, collected GPS data and collected Wi-Fi data, the surveying and mapping data, the GPS data and the Wi-Fi data in a single group of triplet data correspond to same collecting position and same collecting moment.

8. The electronic device of claim 7, wherein the inputting the collected triplet data into the first neural network, comprises:
generating two-dimensional matrices based on the collected surveying and mapping data, the collected GPS data, and the collected Wi-Fi data, respectively, and inputting three generated two-dimensional matrices, as three-channel data, into the first neural network.

9. The electronic device of claim 7, wherein the determining the building according to the at least one coordinate data, comprises:
determining a first position point based on the at least one coordinate data, the determined building being a building where the first position point is located;
alternatively,
determining a plurality of position points based on the at least one coordinate data, the determined building being a building surrounded by a surrounding frame constituted by the plurality of position points.

10. The electronic device of claim 6, wherein the surveying and mapping data comprises at least one selected from building block shape, building floor height, and point-of-interest POI information corresponding to the building.

11. A non-transitory computer-readable storage medium being stored with computer instructions for causing a computer to perform operations of:
acquiring a building fingerprint library, the building fingerprint library comprising a plurality of groups of triplet data and a plurality of corresponding building information, wherein a single group of triplet data comprises surveying and mapping data, GPS data and Wi-Fi data;
receiving a positioning request, the positioning request comprising first triplet data, the first triplet data comprising first surveying and mapping data, first GPS data, and first Wi-Fi data;
calculating a similarity between the first triplet data and the plurality of groups of triplet data in the building fingerprint library, respectively; and
determining building information corresponding to the positioning request according to the calculated similarity;
wherein constructing the building fingerprint library comprises:
collecting a plurality of groups of triplet data, annotating each group of triplet date with corresponding building information, using a plurality of groups of annotated triplet data as training data to train a neural network, and obtaining a building positioning model after training;
inputting a plurality of groups of triplet data to be positioned into the building positioning model for positioning to obtain a plurality of building information; and
constructing the building fingerprint library based on the plurality of groups of annotated triplet data and the plurality of groups of triplet data positioned by the building positioning model.

12. The non-transitory computer-readable storage medium of claim 11, wherein the using the plurality of groups of annotated triplet data as the training data to train the neural network, and obtaining the building positioning model after training, comprising:
inputting the collected triplet data into a first neural network, obtaining at least one coordinate data outputted by the first neural network, determining a building according to the at least one coordinate data, using a difference between the determined building and the annotated building as a loss, performing parameter adjustment on the first neural network, and ending training in a case that a training stop condition is reached to obtain the building positioning model;
wherein the collected triplet data comprises collected surveying and mapping data, collected GPS data and collected Wi-Fi data, the surveying and mapping data, the GPS data and the Wi-Fi data in a single group of triplet data correspond to same collecting position and same collecting moment.

13. The non-transitory computer-readable storage medium of claim 12, wherein the inputting the collected triplet data into the first neural network, comprises:
generating two-dimensional matrices based on the collected surveying and mapping data, the collected GPS data, and the collected Wi-Fi data, respectively, and inputting three generated two-dimensional matrices, as three-channel data, into the first neural network.

14. The non-transitory computer-readable storage medium of claim 12, wherein the determining the building according to the at least one coordinate data, comprises:
determining a first position point based on the at least one coordinate data, the determined building being a building where the first position point is located;
alternatively,
determining a plurality of position points based on the at least one coordinate data, the determined building being a building surrounded by a surrounding frame constituted by the plurality of position points.

15. The non-transitory computer-readable storage medium of claim 11, wherein the surveying and mapping data comprises at least one selected from building block shape, building floor height, and point-of-interest POI information corresponding to the building.

16. A terminal device, comprising: a processor; and a memory configured for storing a computer program; the processor calling and executing the computer program stored in the memory, and executing the method of claim 1.

17. The terminal device of claim 16, wherein the using the plurality of groups of annotated triplet data as the training data to train the neural network, and obtaining the building positioning model after training, comprising:
inputting the collected triplet data into a first neural network, obtaining at least one coordinate data outputted by the first neural network, determining a building according to the at least one coordinate data, using a difference between the determined building and the annotated building as a loss, performing parameter adjustment on the first neural network, and ending training in a case that a training stop condition is reached to obtain the building positioning model;
wherein the collected triplet data comprises collected surveying and mapping data, collected GPS data and collected Wi-Fi data, the surveying and mapping data, the GPS data and the Wi-Fi data in a single group of triplet data correspond to same collecting position and same collecting moment.

18. The terminal device of claim 17, wherein the inputting the collected triplet data into the first neural network, comprises:
generating two-dimensional matrices based on the collected surveying and mapping data, the collected GPS data, and the collected Wi-Fi data, respectively, and inputting three generated two-dimensional matrices, as three-channel data, into the first neural network.

19. The terminal device of claim 17, wherein the determining the building according to the at least one coordinate data, comprises:
determining a first position point based on the at least one coordinate data, the determined building being a building where the first position point is located;
alternatively,
determining a plurality of position points based on the at least one coordinate data, the determined building being a building surrounded by a surrounding frame constituted by the plurality of position points.

20. The terminal device of claim 16, wherein the surveying and mapping data comprises at least one selected from building block shape, building floor height, and point-of-interest POI information corresponding to the building.
